(19) United States
(12) Patent Application Publication
(10) Pub. No.: US 2022/0203142 A1
(43) Pub. Date: Jun. 30, 2022

(54) Face mask with Microporous Filter Membrane Layer

(71) Applicant: Charles Connolly, Alameda, CA (US)

(72) Inventor: Charles Connolly, Alameda, CA (US)

(21) Appl. No.: 17/561,527

(22) Filed: Dec. 23, 2021

Related U.S. Application Data
(60) Provisional application No. 63/131,677, filed on Dec. 29, 2020.

(51) Int. Cl. A62B 23/02; B01D 46/54; B01D 46/00; A41D 13/11

(52) U.S. Cl. CPC A62B 23/025; B01D 46/543; B01D 46/0032; B01D 2275/30; B01D 2279/40; B01D 2279/65; B01D 2275/10; A41D 13/1161

(57) ABSTRACT

A face mask with microporous filter membrane layer is presented. The face mask with microporous filter membrane layer contains a mask body at least one strap and a sealing element. The mask body contains a first end a second end an outer layer at least one intermediate layer and an inner layer. The first end and the second end are terminally positioned longitudinally opposite to each other along the mask body. The at least one strap is distributed about the first end and the second end. The sealing element is perimetrically connected along the outer layer inner layer and the at least one intermediate layer. The at least one intermediate layer is connected between the outer layer and the inner layer through the sealing element

### FIELD OF THE INVENTION

The present invention generally relates to masks. More specifically, the present invention relates to a face mask that offers effective bacterial filtration.

### BACKGROUND OF THE INVENTION

A device for covering the face to protect the user from particles and viruses through effective bacterial filtration is in demand. Many people wear face masks for various reasons, and people use face masks in many circumstances to prevent themselves from infectious diseases.

In recent years, the prevalence of infectious diseases has posed a notably serious threat to public health. Diseases have many vectors, but transmission by respiratory droplets, or airborne transmission, has the greatest potential to disrupt social intercourse. Many people are suffering from a new highly contagious coronavirus called COVID-19. On Mar. 11, 2020, the World Health Organization declared the COVID-19 outbreak a pandemic. The U.S. Centers for Disease Control and Prevention (CDC) have reported several hundred thousand confirmed cases of the virus, which have caused deaths in approximately 150 countries. Accordingly, there is increased interest in reducing the risk of infection in many areas throughout the nation, including in doctor's and dentist's offices as well as in nonhealthcare settings, such as businesses, offices, schools, and other places where people congregate.

Infection experts recommend that people use their arms to catch sneezes and coughs, such as by using the crook of the arm, or inner elbow, to prevent the spread of germs. However, this method does not solve the problem of having one's clothing or arms covered with germs, including sputum (mucus, phlegm, and other such matter).

Face masks can protect the wearer and people near the wearer from contracting infections via bacteria and viral particles. As a result, the COVID-19 pandemic has triggered a surge in demand for face masks to protect against disease transmission.

Different types of masks offer different levels of protection to the user. Surgical masks and unvented KN95 respirators can be used to reduce outward particle emission during speaking and coughing, but few studies have examined particle emission by mask wearers into the surrounding air, and most masks that have a high bacterial retention rate are expensive, with some including an ineffective filtration mechanism. Thus, there is a need for a device that solves these problems.

The present invention is intended to address problems associated with and/or otherwise improve on conventional devices through an innovative face mask device that is designed to provide a convenient and efficient means of protecting people from bacterial infection by filtration while incorporating other problem-solving features.

### SUMMARY OF THE INVENTION

The present invention is a face mask with microporous filter membrane layer. The face mask with microporous filter membrane layer comprises a mask body at least one strap and a sealing element. The mask body comprises a first end a second end an outer layer at least one intermediate layer and an inner layer. The first end and the second end are terminally positioned longitudinally opposite to each other along the mask body. The at least one strap is distributed about the first end and the second end. The sealing element is perimetrically connected along the outer layer inner layer and the at least one intermediate layer. The at least one intermediate layer is connected between the outer layer and the inner layer through the sealing element

### BRIEF DESCRIPTION OF THE DRAWINGS

FIG. 1 is an illustration of one embodiment of the present invention.

FIG. 2 is a perspective view of the present invention.

FIG. 3 is an exploded view of the present invention.

FIG. 4 is a top view of the present invention.

FIG. 5 is a cross section view of the present invention taken along cutting line A-A in FIG. 4

FIG. 6 is a detailed view of the present invention taken along circle B in FIG. 5

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

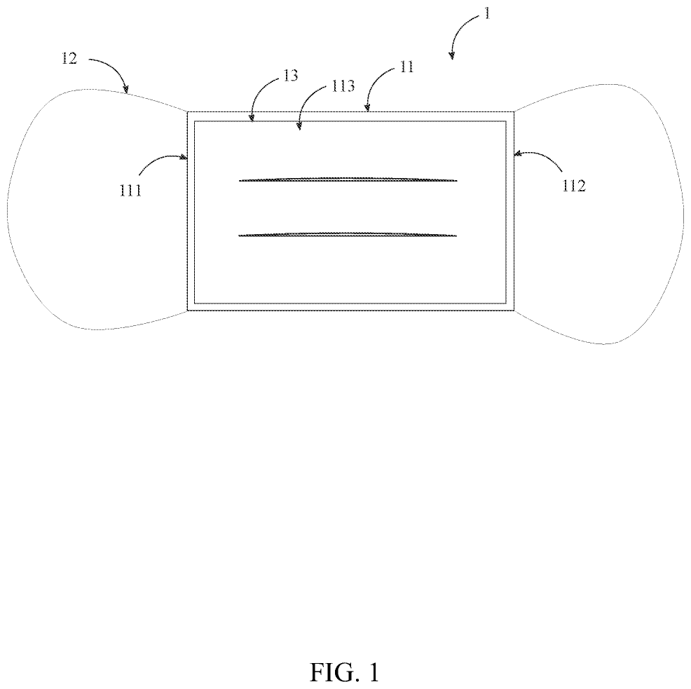

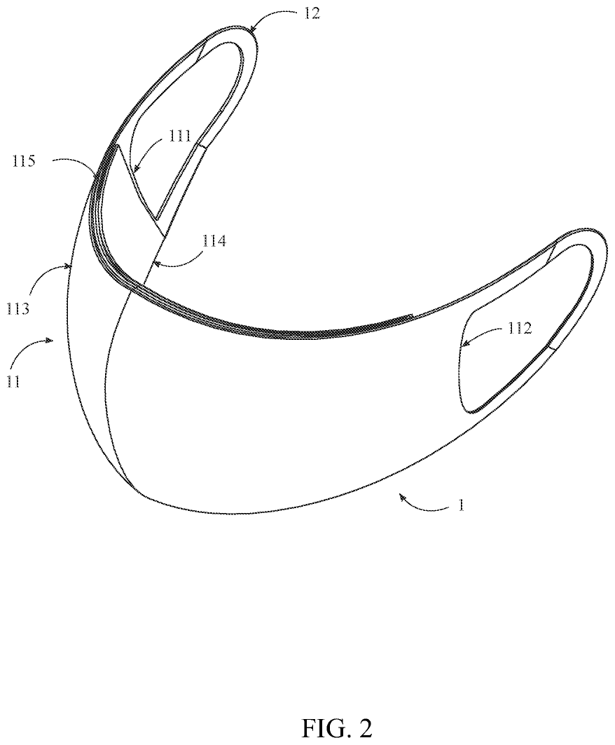

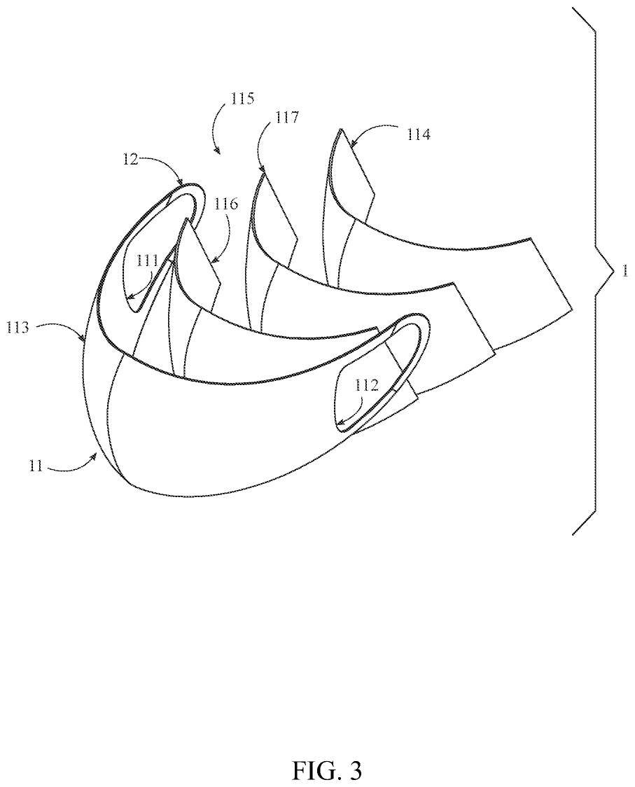

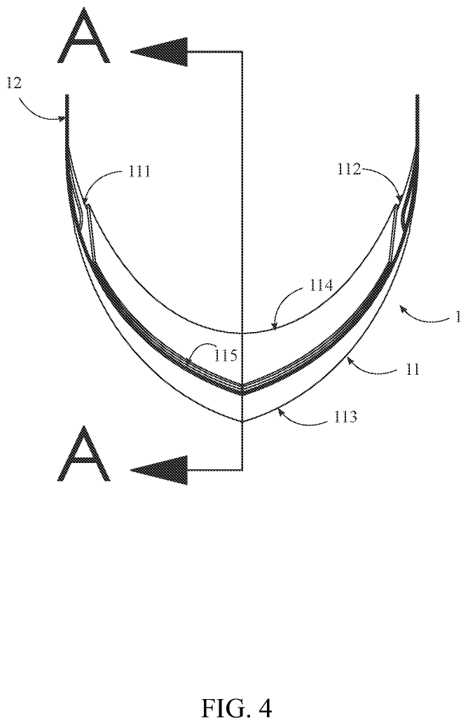

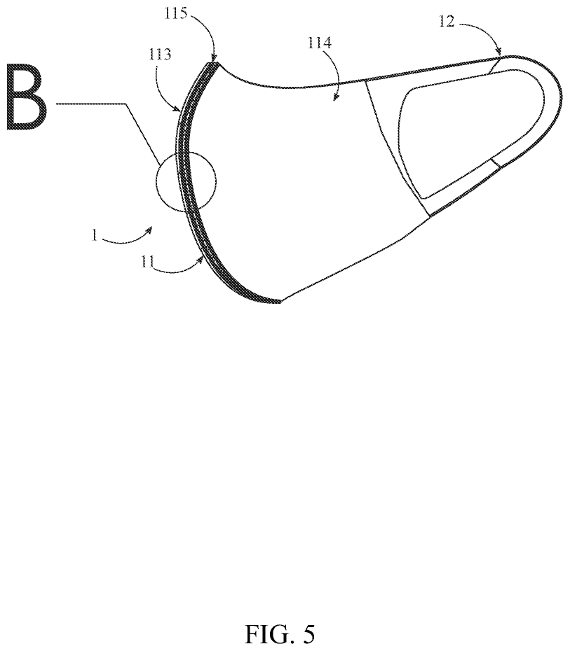

In reference to FIGS. 1-5, the present invention is a face mask with microporous filter membrane layer 1. In reference to FIGS. 1-6, the face mask with microporous filter membrane layer 1 comprises a mask body 11, at least one strap 12, and a sealing element 13. The mask body 11 comprises a first end 111, a second end 112, an outer layer 113, at least one intermediate layer 115, and an inner layer 114. The first end 111 and the second end 112 are terminally positioned longitudinally opposite to each other along the mask body 11. The at least one strap 12 is distributed about the first end 111 and the second end 112. The sealing element 13 is perimetrically connected along the outer layer 113, inner layer 114, and the at least one intermediate layer 115. The at least one intermediate layer 115 is connected between the outer layer 113 and the inner layer 114 through the sealing element 13. In the preferred embodiment, the mask body 11 takes the form of any suitable mask shape that contours to a user's lower face profile, adequately covering the mouth, cheek, nose, and chin regions of the user. In the preferred embodiment, the at least one strap 12 takes the form of any suitable strapping implement that mounts the mask body 11 along the user's lower face. In the preferred embodiment, the at least one strap 12 specifically takes the form of ear loops that attach on the first end 111 and the second end 112 portions of the mask such that the user can wear the mask body 11 along their lower face while looping each of the at least one strap 12 along their ears. In the preferred embodiment, the sealing element 13 takes the form of any suitable sealing implement that binds the layers that constitutes the mask body 11 together, such as, but not limited to stitching, heat binding, or any other suitable type of sealing implement.

In the preferred embodiment, the outer layer 113 serves as the outer most layer of the mask body 11 that is preferably made out of a moisture resistant fabric effective in blocking dust and other microparticles. In the preferred embodiment, the inner layer 114 serves as the inner most layer of the mask body 11 that comes in contact with the user's lower face upon wearing the present invention. The inner layer 114 is made out cotton or any other suitable material. In the preferred embodiment, the at least one intermediate layer 115 serves as the filtration layer of the mask body 11. More specifically, the at least one intermediate layer 115 takes the form of one or more filter layers that facilitates total particulate filtration along the mask body 11.

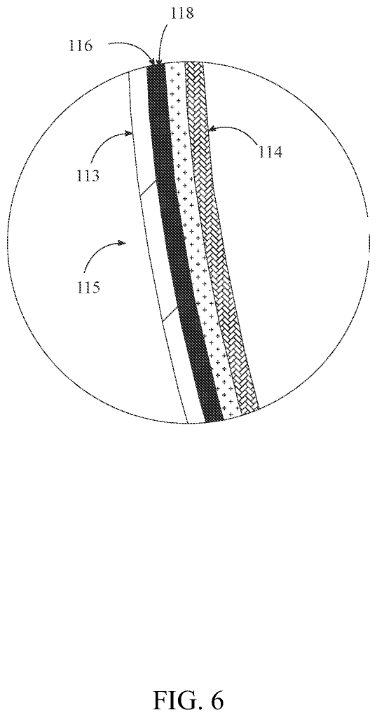

In the preferred embodiment, the at least one intermediate layer 115 comprises a first intermediate layer 116 and a second intermediate layer 117, as shown in FIG. 6. The first intermediate layer 116. The first intermediate layer 116 is connected between the outer layer 113 and the inner layer 114. In the preferred embodiment, the first intermediate layer 116 is constructed out of a microporous sterilizing grade membrane that filters out any microparticles while allowing the user to breathe through the at least one intermediate layer 115. The second intermediate layer 117 is connected between the outer layer 113 and the inner layer 114. In the preferred embodiment, the second intermediate layer 117 is constructed out of a positively charged microporous sterilizing grade membrane, working in conjunction with the first intermediate layer 116 by acting as a positively charged layer to filter negatively charged microparticles. More specifically, the positively charged second intermediate layer 117 attracts the negatively charged lipid coating found in bioparticles such as viruses. In the preferred embodiment, the first intermediate layer 116 and the second intermediate layer 117 are microporous layers. In the preferred embodiment, the first intermediate layer 116 is made of at least one material selected from the group consisting of: polytetrafluoroethylene, polyvinylylidine difluoride, nylon, polyethersulfone, polysulfone, polyvinylidene fluoride, polypropylene, cellulose acetate, polycarbonate, cellulose esters, and combinations thereof. In the preferred embodiment, the second intermediate layer 117 is made of at least one material selected from the group consisting of: polytetrafluoroethylene, polyvinylylidine difluoride, nylon, polyethersulfone, polysulfone, polyvinylidene fluoride, polypropylene, cellulose acetate, polycarbonate, cellulose esters, and combinations thereof. In one embodiment, the first intermediate layer 116 is made out of a polytetrafluoroethylene microporous layer. In this embodiment, the second intermediate layer 117 is made of a nylon microporous layer. In the preferred embodiment, the at least one intermediate layer 115 comprises a plurality of pores 118, as shown in FIG. 6. The plurality of pores 118 is distributed across the at least one intermediate layer 115. The pore diameter of the plurality of pores 118 ranges from 0.1-0.25 microns. In another embodiment, the pore diameter of the plurality of pores 118 ranges from 0.1-0.65 microns. In the preferred embodiment, the pore diameter of the plurality of pores 118 is 0.2 microns. The 0.2 micron pore diameter provides sufficient protection from microparticles while allowing the user to comfortably breath through the mask body 11.

Although the invention has been explained in relation to its preferred embodiment, it is to be understood that many other possible modifications and variations can be made without departing from the spirit and scope of the invention as hereinafter claimed.

What is claimed is:

1. A face mask with microporous filter membrane layer comprising:
a mask body;
at least one strap;
a sealing element;
the mask body comprising a first end, a second end, an outer layer, at least one intermediate layer, and an inner layer;
the first end and the second end being terminally positioned longitudinally opposite to each other along the mask body;
the at least one strap being distributed about the first end and the second end;
the sealing element being perimetrically connected along the outer layer, inner layer, and the at least one intermediate layer; and
the at least one intermediate layer being connected between the outer layer and the inner layer through the sealing element.

2. The face mask with microporous filter membrane layer as claimed in claim 1 comprising:
the at least one intermediate layer comprising a first intermediate layer; and
the first intermediate layer being connected between the outer layer and the inner layer.

3. The face mask with microporous filter membrane layer as claimed in claim 2, wherein the first intermediate layer is constructed out of a microporous sterilizing grade membrane.

4. The face mask with microporous filter membrane layer as claimed in claim 1 comprising:
the at least one intermediate layer comprising a second intermediate layer; and
the second intermediate layer being connected between the outer layer and the inner layer.

5. The face mask with microporous filter membrane layer as claimed in claim 1, wherein the second intermediate layer is constructed out of a positively charged microporous sterilizing grade membrane.

6. The face mask with microporous filter membrane layer as claimed in claim 1, wherein the at least one intermediate layer is a first intermediate layer and a second intermediate layer, and wherein the first intermediate layer and the second intermediate layer are microporous layers.

7. The face mask with microporous filter membrane layer as claimed in claim 6, wherein the first intermediate layer is made of at least one material selected from the group consisting of: polytetrafluoroethylene, polyvinylylidine difluoride, nylon, polyethersulfone, polysulfone, polyvinylidene fluoride, polypropylene, cellulose acetate, polycarbonate, cellulose esters, and combinations thereof.

8. The face mask with microporous filter membrane layer as claimed in claim 6, wherein the second intermediate layer is made of at least one material selected from the group consisting of: polytetrafluoroethylene, polyvinylylidine difluoride, nylon, polyethersulfone, polysulfone, polyvinylidene fluoride, polypropylene, cellulose acetate, polycarbonate, cellulose esters, and combinations thereof.

9. The face mask with microporous filter membrane layer as claimed in claim 6, wherein the first intermediate layer is made out of polytetrafluoroethylene.

10. The face mask with microporous filter membrane layer as claimed in claim 6, wherein the second intermediate layer is made of nylon.

11. The face mask with microporous filter membrane layer as claimed in claim 1 comprising:
at least one intermediate layer comprising a plurality of pores;
the plurality of pores being distributed across the at least one intermediate layer; and
the pore diameter of the plurality of pores being 0.1-0.25 microns.

12. The face mask with microporous filter membrane layer as claimed in claim 1 comprising:
at least one intermediate layer comprising a plurality of pores;
the plurality of pores being distributed across the at least one intermediate layer; and
the pore diameter of the plurality of pores being 0.1-0.65 microns.

13. The face mask with microporous filter membrane layer as claimed in claim 1 comprising:
the at least one intermediate layer comprising a first intermediate layer and a second intermediate layer;
the first intermediate layer and the second intermediate layer being connected between the outer layer and the inner layer; and
the at least one intermediate layer comprising a second intermediate layer.

14. The face mask with microporous filter membrane layer as claimed in claim 1 comprising:
the at least one intermediate layer comprising a first intermediate layer and a second intermediate layer, wherein the first intermediate layer is constructed out of a microporous sterilizing grade membrane;
the first intermediate layer and the second intermediate layer being connected between the outer layer and the inner layer; and
the at least one intermediate layer comprising a second intermediate layer.

15. The face mask with microporous filter membrane layer as claimed in claim 1 comprising:
the at least one intermediate layer comprising a first intermediate layer and a second intermediate layer, wherein the second intermediate layer is constructed out of a positively charged microporous sterilizing grade membrane
the first intermediate layer and the second intermediate layer being connected between the outer layer and the inner layer; and
the at least one intermediate layer comprising a second intermediate layer.

16. The face mask with microporous filter membrane layer as claimed in claim 1 comprising:
the at least one intermediate layer comprising a first intermediate layer and a plurality of pores;
the first intermediate layer being connected between the outer layer and the inner layer;
the plurality of pores being distributed across the first intermediate layer; and
the pore diameter of the plurality of pores being 0.1-0.25 microns.

17. The face mask with microporous filter membrane layer as claimed in claim 1 comprising:
the at least one intermediate layer comprising a first intermediate layer and a plurality of pores;
the first intermediate layer being connected between the outer layer and the inner layer;
the plurality of pores being distributed across the first intermediate layer; and
the pore diameter of the plurality of pores being 0.1-0.65 microns.

18. The face mask with microporous filter membrane layer as claimed in claim 1 comprising:
the at least one intermediate layer comprising a first intermediate layer, a second intermediate layer, and a plurality of pores;
the first intermediate layer and the second intermediate layer being connected between the outer layer and the inner layer;
the plurality of pores being distributed across the first intermediate layer and the second intermediate layer; and
the pore diameter of the plurality of pores being 0.1-0.25 microns.

19. A face mask with microporous filter membrane layer comprising:
a mask body;
at least one strap;
a sealing element;
the mask body comprising a first end, a second end, an outer layer, at least one intermediate layer, and an inner layer, wherein the at least one intermediate layer is a first intermediate layer and a second intermediate layer, and wherein the first intermediate layer and the second intermediate layer are microporous layers. the first end and the second end being terminally positioned longitudinally opposite to each other along the mask body;
the at least one strap being distributed about the first end and the second end;
the sealing element being perimetrically connected along the outer layer, inner layer, and the at least one intermediate layer; and
the at least one intermediate layer being connected between the outer layer and the inner layer through the sealing element.

20. A face mask with microporous filter membrane layer comprising:
a mask body;
at least one strap;
a sealing element;
the mask body comprising a first end, a second end, an outer layer, at least one intermediate layer, and an inner layer;
the at least one intermediate layer comprising a plurality of pores;
the first end and the second end being terminally positioned longitudinally opposite to each other along the mask body;
the at least one strap being distributed about the first end and the second end;
the sealing element being perimetrically connected along the outer layer, inner layer, and the at least one intermediate layer;
the at least one intermediate layer being connected between the outer layer and the inner layer through the sealing element;
the plurality of pores being distributed across the at least one intermediate layer; and
the pore diameter of the plurality of pores being 0.1-0.65 microns.
